(19) United States
(12) Patent Application Publication
(10) Pub. No.: US 2009/0044684 A1
(43) Pub. Date: Feb. 19, 2009

(54) Drum band

(76) Inventor: Alfred Avartanian, Glendale, CA (US)

Correspondence Address: Joseph Curtis Edmondson, 15490 NW Oak Hills Dr, Beaverton, OR, 97006, US

(21) Appl. No.: 11/893,145

(22) Filed: Aug. 14, 2007

(51) Int. Cl. G10D 13/00

(52) U.S. Cl. 84/422.4

(57) ABSTRACT

A musical apparatus comprising, a first ring, a second ring, and a flexible member. The first ring is position on the finger of a drummer, the second ring encircles a drumstick and the flexible member connects the two rings. The flexible member is configured so that the first ring and second ring are offset at an angle that allows the drumstick to properly rest on the hand of the drummer.

### BACKGROUND OF THE INVENTION

The art of playing drums is well known and consists of holding a drumstick and striking a drum. A drumstick is a device used to hit the drums to make a percussive noise. A drummer is the person who plays the drums. A drum consist of at least one membrane, called a “drumhead” or “drumskin”, that is stretched over a shell and struck, either directly with parts of a player's body, or with some sort of implement such as a drumstick, to produce sound.

Drumsticks typically have a smooth surface that allows the drumstick to slip through the hands of the drummer. Also, sweat on the drummer's hands increases the risk of losing the drumstick. In certain situations the release of the drumstick can be disadvantageous, for example, during a parade when the drummer is moving and cannot retrieve the drumstick.

Also, the lack of a drumstick restraint can be dangerous to other individuals. For example, during the vigorous playing of the drums, a player can accidentally release the drumstick resulting in a flying projectile that may injure others.

Many beginners have found it challenging to learn how to play the drums. It can take up to a year for a beginner to learn how to hold the drumsticks in the proper position and at a proper angle. A positioning device attached to the finger and the drumstick may be set such that there is a proper offset between the finger and the drumstick that replicates the proper playing position.

The prior art depicts three devices that use a ring design to affix a finger to the drumstick. The first such device is U.S. Pat. No. 3,365,108 (Jan. 23, 1968) to Giba which uses a two ring structure with a three hundred and sixty degree swivel between the two rings. The '108 patent does not position the drumstick at the proper playing angle rather allows it to spin a complete 360 degrees. Another such device is U.S. Pat. No. 5,370,030 (Dec. 6, 1994) to Horne which uses a flexible ring inserted into the drumstick. The '030 device has the drawback of requiring the finger to be pressed up against the drumstick. Another such device is US Pub No. 2006/0090629 (May 4, 2006) to Nybye uses a rigid ring inserted into the drumstick.

Other devices use a much bulkier apparatus to accomplish the same goal of connecting the hands of the drummer to the stick. The U.S. Pat. No. 5,581,031 (Dec. 3, 1993) to Blankenship, Jr., describes a pistol-type grip with grooves that receive the fingers of the drummer. U.S. Pat. No. 6,810,531 (Nov. 2, 2004) to Lento on uses an entire glove structure to properly align the drumstick to the player hand.

Another device with the US Publication No. 2002/0002895 (Jan. 10, 2002) to Zbrzezny on published on changes the cylindrical portion that is used to grip the drumstick to a hexagonal shape. The article in the '895 publication depicts a device that increases the friction on the drumstick thereby decreasing the slippage of the drumstick from the hand of the musician, but, the device does not prevent the drumstick from being ejected from the hand of the musician.

Lastly, another device is shown in US Publication No. 2006/0027076 (Feb. 9, 2006) to Barke. The device shown in the '076 publication utilizes a spacer with straps to hold the stick in the proper alignment with the hand. The device shown in the '076 publication, like the device shown in the '895 does not prevent the drumstick from being ejected from the hand of the musician.

### SUMMARY OF THE INVENTION

While describing the invention and its embodiments various terms will be used for the sake of clarity. These terms are intended to not only include the recited embodiments, but also all equivalents that perform substantially the same function, in substantially the same manner to achieve the same result.

The device is directed at the drum band apparatus and the method of using the same. The device is useful for attaching a generic cylindrical drumstick to a drummer's hand, keeping the drumstick at a proper angle to the hand, allowing the drummer to have greater control over the drumstick, and allows the drummer to never drop the drumstick. The device also allows a quick change of drumsticks if the drumstick shatters. The device also provides support to the drumstick to prevent shattering. Also, the device accomplishes the previously mentioned objectives while being inconspicuous. Lastly, no modification of a cylindrical drumstick is required.

It is an object of this invention to provide a drum band that attaches on the finger of the drummer and on a part of the stick.

It is another object of this invention to provide a drum band that positions the stick in the palm of the drummer in a manner that is most likely to aid the proper holding of the drumstick.

The apparatus and method of this device has several features, no single one of which is solely responsible for its desirable attributes. Without limiting the scope of this invention as expressed by the claims that follow, its more prominent features will now be discussed.

### BRIEF DESCRIPTION OF THE DRAWINGS

FIG. 1: shows the side view of the drum band apparatus.

FIG. 2: show the side view of the drum band apparatus.

FIG. 3: shows the isometric view of the drum band apparatus.

FIG. 4a: shows the drum band apparatus attached to a right hand and attached to a generic drumstick from a palm up view.

FIG. 4b: shows the drum band apparatus attached to a right hand from the side view.

FIG. 5a: shows the drum band apparatus attached to a right hand and attached to a generic drumstick from a palm up view.

FIG. 5b: shows the drum band apparatus attached to a right hand from the side view.

FIG. 5c shows the drum band apparatus laid palm up and affixed to the middle finger.

FIG. 5d shows the drum band apparatus with the palm downwards and the index finger and thumb holding the drumstick.

FIG. 5e shows a palm down view of the drum band apparatus attached with the drumstick held between the thumb and index finger.

FIG. 6a: Shows the bottom view of the drum band for the left hand.

FIG. 6b: Shows the bottom view of the drum band for the right hand.

### DETAILED DESCRIPTION

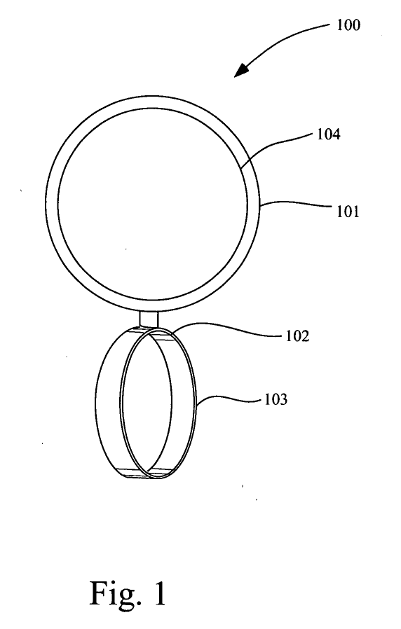

Now referring to FIG. 1. FIG. 1 shows a frontal view of the drumstick band 100. The drumstick band 100 consists of a finger ring 101 and a drumstick ring 103. The finger ring 101 is connected to the drumstick ring 103 using a flexible member 102. The finger ring 101 is sized so that the inner diameter of the finger ring 104 of the finger ring 101 is sized to comfortably fit on a drum player's finger.

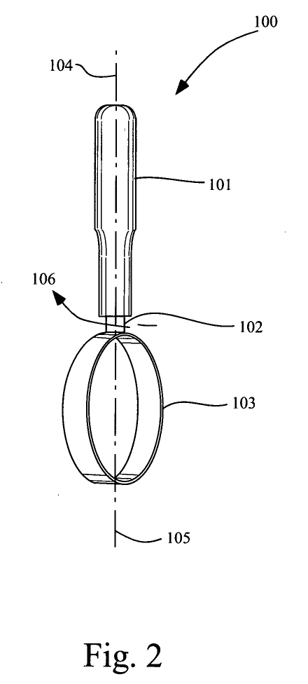

Now referring to FIG. 2. FIG. 2 is a side view of the drumstick band 100. As shown, the finger ring 101 and the drumstick ring 103 are connected with a flexible member 102. For the purposes of orientation a finger plane 104 slices through the finger ring 101 and a drumstick plane 105 intersects the drumstick ring 103. The finger plane 104 and the drumstick plane 105 are offset by an angle 106.

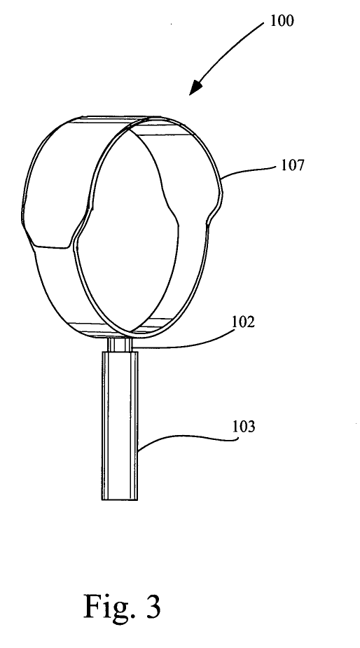

Now referring to FIG. 3. FIG. 3 is a close up view of the drumstick band 100. As shown the finger ring 101 may have an elongated section 107 on the top of the finger ring 101 for the purposes of ornamentation.

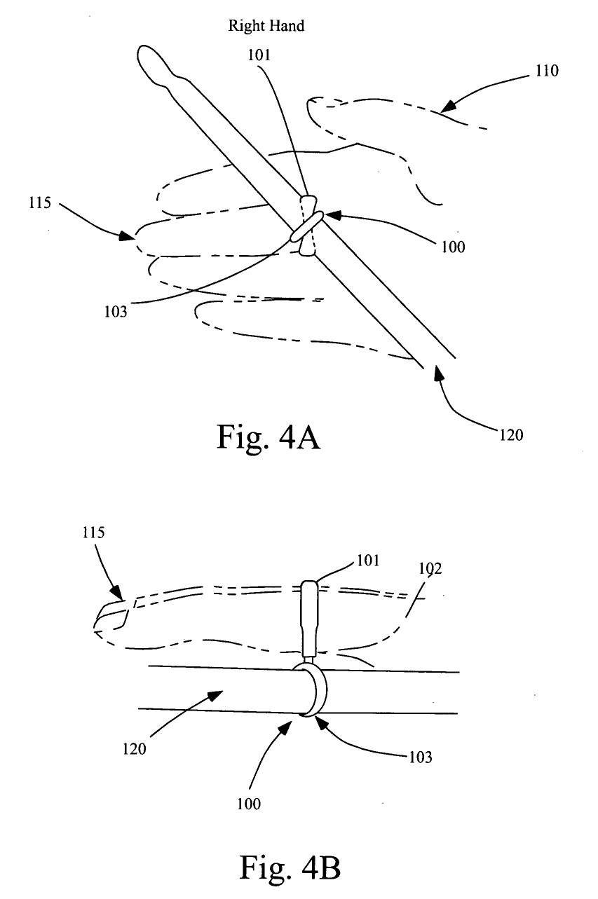

Now referring to FIG. 4a. FIG. 4a depicts a view of the drumstick band 100 as held by a hand 110 with the left-hand palm facing upwards. The finger ring 101 is slipped through the middle finger 115 and the drumstick 120 is inserted through the drumstick ring 103. As shown the drumstick 120 is at an angle to the finger 115 as set by the angle between the finger ring 101 and the drumstick ring 103.

Now referring to FIG. 4b. FIG. 4b shows a side view of the drumstick band 100 where the hand is left hand palm down. As shown the finger ring 101 is looped around the middle finger 115, the flexible member 102 is connected to the finger ring 101 and the drumstick ring 103 is connected to the flexible member 102. The flexible member 102 is of such a length to allow a gap between the palm of the hand and the drumstick 120.

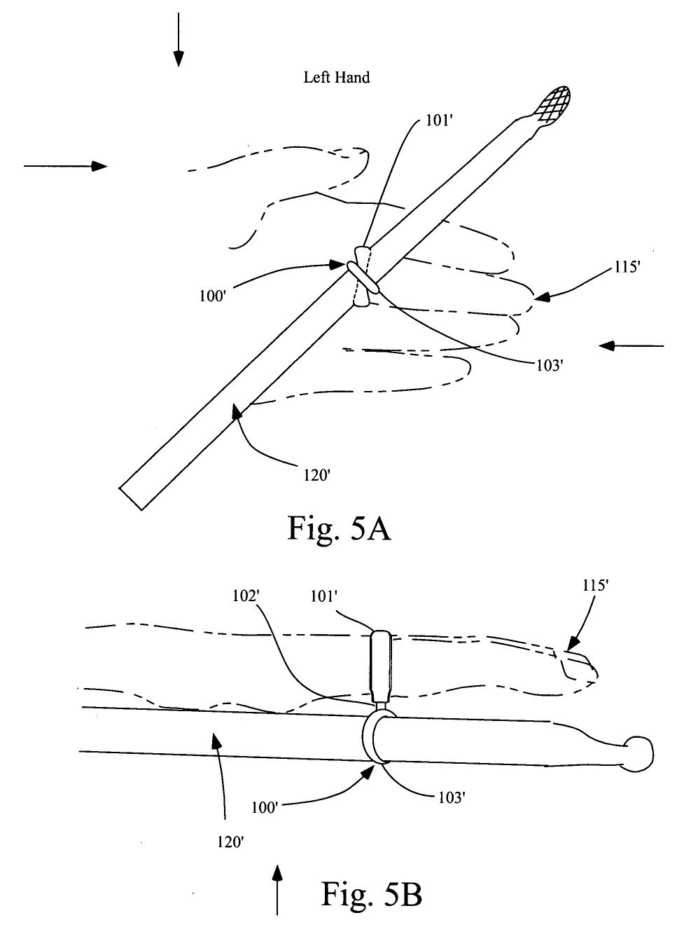

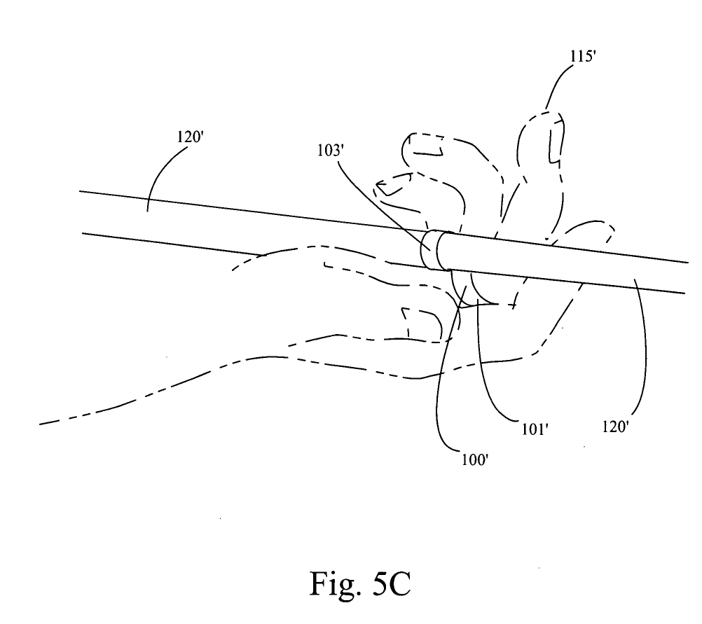

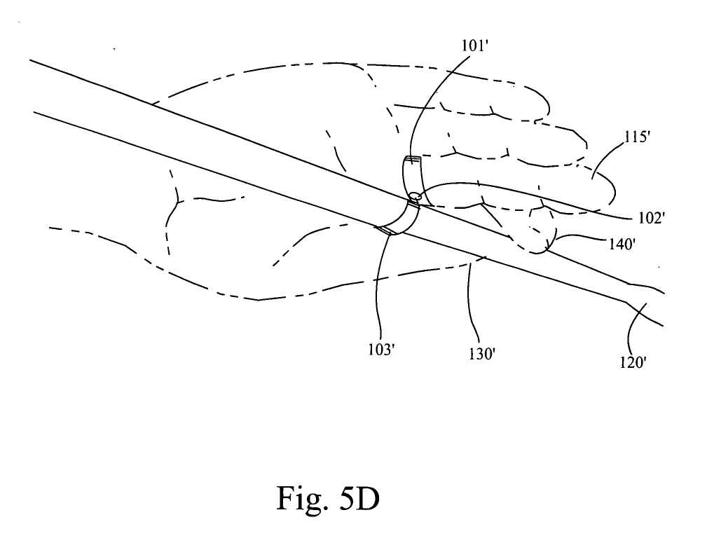

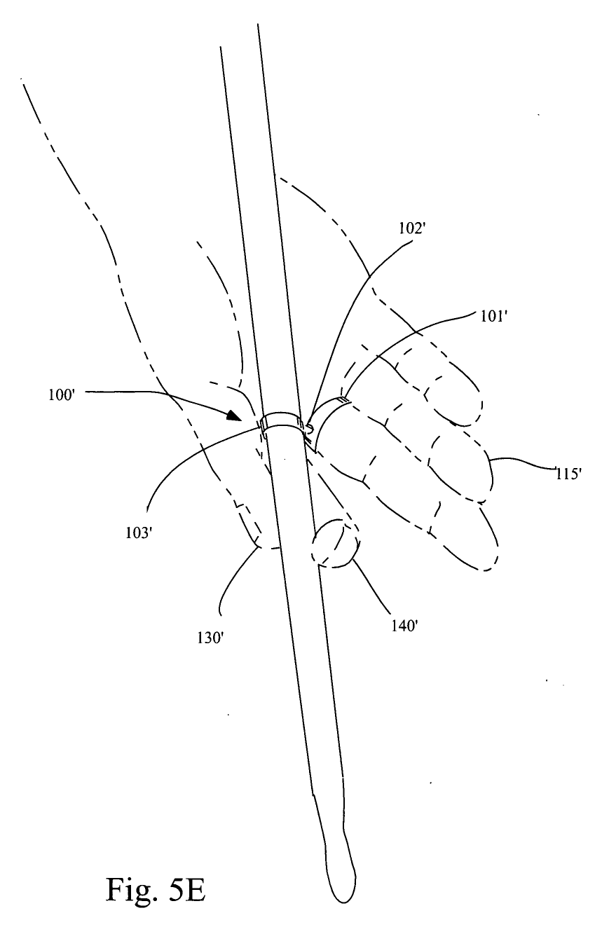

Now referring to FIG. 5a. FIG. 5a depicts a view of the drumstick band 100′ as held by a hand 110′ with the right hand palm facing upwards. The finger ring 101′ is slipped through the middle finger 115′ and the drumstick 120′ is inserted through the drumstick ring 103. As shown the drumstick 120′ is at an angle to the finger 115′ as set by the angle between the finger ring 101′ and the drumstick ring 103′.

Now referring to FIG. 5b. FIG. 5b shows a side view of the drumstick band 100′ where the hand is right hand palm down. As shown the finger ring 101′ is looped around the middle finger 115′, the flexible member 102′ is connected to the finger ring 101′ and the drumstick ring 103′ is connected to the flexible member 102′. The flexible member 102′ is of such a length to allow a gap between the palm of the hand and the drumstick 120′.

Now referring to FIG. 5c. FIG. 5c shows a palm up view of the drumstick band 100′. As shown the finger ring 101′ is looped around the middle finger 115′, the flexible member (not shown) is connected to the finger ring 101′ and the drumstick ring 103′ is connected to the flexible member 102′.

Now referring to FIG. 5d. FIG. 5d shows a palm down view of the drumstick band 100′. As shown the finger ring 101′ is looped around the middle finger 115′, the flexible member (not shown) is connected to the finger ring 101′ and the drumstick ring 103′ is connected to the flexible member 102′. The flexible member 102′ is set at an angle so that the index finger 140′ and the thumb 130′ hold the drumstick 120′ in the proper position for playing the drums.

Now referring to FIG. 5e. FIG. 5e shows another palm down view of the drumstick band 100′. As in FIG. 5d, the index finger 140′ and the thumb 130′ grasp the drumstick at an angle set by the flexible member 102′. This flexible member 102′ is set at an angle that is the proper holding position for a drumstick.

The difference between FIGS. 4 and 5 being the right hand and left hand orientation of the drumstick bands 100, 100′.

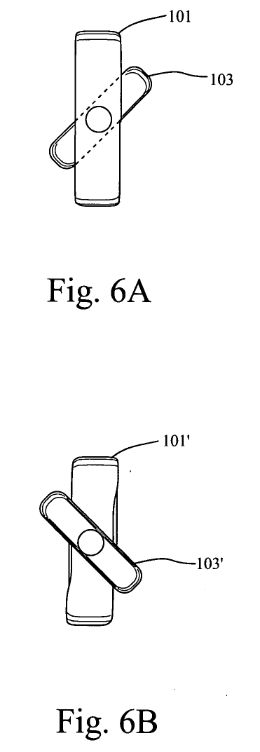

Now referring to FIGS. 6a and 6b, the orientation of the bands 100 and 100′ is shown in detail. The finger band 101, 101′ and the drumstick band 103, 103′ are oriented in such a way to hold the drumsticks at a natural playing angle.

Other embodiments of the device allow for the flexible member to be detached from the finger ring. This allows the finger ring to be worn ornamentally and also providing for the connection of the flexible member with ease.

1. A musical apparatus comprising, a first ring, a second ring, and a flexible member;
wherein said finger ring comprises an inner part and an outer part;
wherein said drumstick ring comprises an inner part and an outer part.
said flexible member comprising a top part, a bottom part;
wherein said top part of the flexible member is connected to said finger ring, and wherein said bottom part of the flexible member is connected to the drumstick ring
wherein the finger ring further comprises an inner part dimensioned to encircle a finger; and
wherein said drumstick ring comprises an inner part dimensioned to encircle a drumstick; and
and wherein the finger ring, the drumstick ring, and the flexible member form an continuous assembly,
such that when the finger ring and the drumstick ring are rotated relative from a offset position to a displaced position, the flexible member exerts a counteracting force to restore the finger ring and the drumstick ring from the displaced position to the offset position.

2. (canceled)

3. (canceled)

4. A musical apparatus as in claim 1, wherein a plane bisecting the finger ring and a plane bisecting the drumstick ring are offset by an angle.

5. A musical apparatus as in claim 4, wherein said angle is approximately 45 degrees.

6. A musical apparatus as in claim 1 wherein there is a means for detaching said top part of the flexible member from said first ring.

7. A musical apparatus as in claim 1 wherein there is a means for detaching said bottom part of the flexible member from said bottom ring.

8. A method for the improvement of playing drums, said method consisting of
a) placing a finger ring on the finger of the person;
b) placing a drumstick ring on a drumstick;
c) connecting the finger ring and a drumstick ring with a flexible member;
such that the flexible member is positioned so that the finger ring is at an angle to the drumstick ring.
and wherein the flexible member forms an continuous integrated assembly,
such that when the finger ring and the drumstick ring are rotated relative from a resting position to a rotated position, the flexible member exerts a counteracting force to restore the finger ring and the drumstick ring from the displaced position to the offset position.
